(19) United States
(12) Patent Application Publication
(10) Pub. No.: US 2023/0109177 A1
(43) Pub. Date: Apr. 6, 2023

(54) SPEECH EMBEDDING APPARATUS, AND METHOD

(71) Applicant: NEC Corporation, Minato-ku, Tokyo (JP)

(72) Inventors: Kong Aik LEE, Tokyo (JP); Takafumi Koshinaka, Tokyo (JP)

(73) Assignee: NEC Corporation, Minato-ku, Tokyo (JP)

(21) Appl. No.: 17/793,220

(22) PCT Filed: Jan. 31, 2020
(86) PCT No.: PCT/JP2020/003745

§ 371 Date: Jul. 15, 2022

(51) Int. Cl. G10L 25/03; G10L 25/30

(52) U.S. Cl. CPC G10L 25/03; G10L 25/30

(57) ABSTRACT

A frame processor 81 calculates, from a first sequence of feature vectors, a second sequence of frame-level feature vectors. A posterior estimator 82 calculates posterior probabilities for each vector included in the second sequence to a cluster. A statistics calculator 83 calculates a sufficient statistic used for extracting an i-vector by using the second sequence, the posterior probabilities, a mean vector of each cluster calculated at the time of learning of the frame processor 81 and the posterior estimator 82, and a global covariance matrix calculated based on the mean vector.

### TECHNICAL FIELD

The present invention relates to a speech embedding apparatus, speech embedding method, and non-transitory computer readable recording medium storing a speech embedding program for extracting i-vector.

### BACKGROUND ART

State-of-the-art speaker recognition systems consist of a speaker embedding front-end followed by a scoring backend. Two common forms of speaker embedding are i-vector and x-vector. For scoring backend, probabilistic linear discrimination analysis (PLDA) is commonly used.

Non Patent Literature 1 discloses the i-vector. The i-vector is a fixed-length low-dimensional representation of variable-length speech utterance. Mathematically, it is defined as the posterior mean of a latent variable in a multi-Gaussian factor analyzer.

Non Patent Literature 2 discloses the x-vector. Conventional x-vector extractor is a deep neural network (DNN) consisting of three functional blocks shown below. The first functional block is a frame-level feature extractor implemented with a time-delay neural network (TDNN). The second functional block is a statistical pooling layer. The role of the pooling layer is to compute the average and standard deviation from the frame-level feature vectors produced by the TDNN. The third functional block is utterance classification.

The good performance on the x-vector is attained by (1) training the network with large amount of training data, and (2) discriminative training (e.g., multiclass cross entropy cost, angular margin cost).

Further, Non Patent Literature 3 and Non Patent Literature 4 disclose an x-vector with NetVLAD pooling. Instead of temporal average and standard deviation, NetVLAD as disclosed in Non Patent Literature 3 and Non Patent Literature 4 uses cluster-wise temporal aggregation.

In addition, Non Patent Literature 5 discloses TDNN.

### CITATION LIST

### Non Patent Literature

[NPL 1]
N. Dehak, P. Kenny, R. Dehak, P. Dumouchel, and P. Ouellet, “Front-end factor analysis for speaker verification,” IEEE Transactions on Audio, Speech and Language Processing, vol. 19, no. 4, pp. 788-798, 2010.

[NPL 2]
D. Snyder et al, “X-vectors: robust DNN embeddings for speaker recognition,” in Proc. IEEE ICASSP, 2018.

[NPL 3]
Arandjelovic et al, “NetVLAD: CNN architecture for weakly supervised place recognition,” in Proc. IEEE CVPR, 2016, pp. 5297-5307.

[NPL 4]
Xie et al, “Utterance-level aggregation for speaker recognition in the wild,” in Proc. IEEE ICASSP, 2019, pp. 5791-5795.

[NPL 5]
V. Peddinti, D. Povey, S. Khudanpur, “A time delay neural network architecture for efficient modeling of long temporal contexts,” in Proc. Interspeech, 2015, pp. 3214-3218.

### SUMMARY OF INVENTION

### Technical Problem

In the following explanation, when using a Greek letter in the text, an English notation of Greek letter may be enclosed in brackets ([ ]). In addition, when representing an upper case Greek letter, the beginning of the word in [ ] is indicated by capital letters, and when representing lower case Greek letters, the beginning of the word in [ ] is indicated by lower case letters.

A general i-vector extractor as disclosed in Non Patent Literature 1 is built upon a Universal Background Model (UBM), which is a Gaussian mixture model (GMM) defined by the parameters {[omega]_{c}, [mu]_{c}, [Sigma]_{c}}_{c=1}^{C} consisting of weights, mean vectors, and covariance matrices.

Note that C is a number of Gaussian components. [omega]_{c} is weights of the c-th Gaussian. [mu]_{c} is a mean vector of the c-th Gaussian. [Sigma]_{c} is a convariance matrix of the c-th Gaussian.

FIG. 6 is an explanatory example illustrating a general extraction process of the i-vector. In FIG. 6, an observation oₜ represents a feature vector of D dimensions at the time step t, and [tau] represents the number of feature vectors in a set or sequence of the observations. Given a sequence of feature vectors {o₁, o₂, . . . , o_{[tau]}}, zero-order statistic and first-order statistic are computed using the UBM.

The zero-order statistic N_{c} and the first-order statistic F_{c} belonging to the c-th Gaussian are computed, for example, by Equations 1 and 2 described below.

[Math. 1]

N_{c}=Σₜ₌₁^{τ}γ_{c,t} (Equation 1)

F_{c}=Σ_{c}^{-1/2}[Σₜ₌₁^{τ}γ_{c,t}(oₜ−μ_{c})] (Equation 2)

The frame alignment [Gamma]_{c,t} (soft membership of a data point) for each Gaussian component is computed, for example, by Equation 3 described below.

$$[ Math . 2 ]$$

$${γ}_{c , t} = \frac{{ω}_{c} N ( {o}_{t} \vert {μ}_{c} , {Σ}_{c} )}{{\sum }_{l = 1}^{C} {ω}_{l} N ( {o}_{t} \vert {μ}_{l} , {Σ}_{l} )} \qquad ( Equation 3 )$$

wherein

$$N ( {o}_{t} \vert {μ}_{c} , {Σ}_{c} ) = \frac{1}{\sqrt{{( 2 π )}^{D} \vert {Σ}_{c} \vert}} exp [ - \frac{1}{2} {( {o}_{t} - {μ}_{c} )}^{T} {\sum }_{c}^{- 1} ( {o}_{t} - {μ}_{c} ) ]$$

Based on these pieces of information (zero-order statistics and first-order statistics), an i-vector is computed. In general, the precision matrix L⁻¹ and i-vector [phi] are computed using Equations 4 and 5 described below. In Equations 4 and 5, T_{C} is a total variability matrix of the c-th Gaussian.

[Math. 3]

ϕ=L⁻¹[Σ_{c=1}^{C}T_{c}^{T}F_{c}] (Equation 4)

L⁻¹=[Σ_{c=1}^{C}N_{c}T_{c}^{T}T_{c}+I]⁻¹ (Equation 5)

However, i-vector extractor consists of a shallow structure, which limits its performance. On the other hand, x-vector disclosed in Non Patent Literatures 2-4 shows good performance, but lacks of generative interpretation. The generative interpretation describes how data is generated in terms of a probabilistic model. By sampling from this probabilistic model, new data are generated.

That is, the x-vector lacks generative interpretation, and therefore no apparent way it could be used for application where generative modeling is required, e.g., text-dependent speaker recognition.

It is an exemplary object of the present invention to provide a speech embedding apparatus, speech embedding method, and non-transitory computer readable recording medium storing a speech embedding program that can extract features in a mode that requires generative modeling, while improving the performance of speech processing application (e.g., speaker recognition).

### Solution to Problem

A speech embedding apparatus including: a frame processor which calculates, from a first sequence of feature vectors, a second sequence of frame-level feature vectors; a posterior estimator which calculates posterior probabilities for each vector included in the second sequence to a cluster; and a statistics calculator which calculates a sufficient statistic used for extracting an i-vector by using the second sequence, the posterior probabilities, a mean vector of each cluster calculated at the time of learning of the frame processor and the posterior estimator, and a global covariance matrix calculated based on the mean vector.

A speech embedding method including: calculating, from a first sequence of feature vectors, a second sequence of frame-level feature vectors; calculating posterior probabilities for each vector included in the second sequence to a cluster; and calculating a sufficient statistic used for extracting an i-vector by using the second sequence, the posterior probabilities, a calculated mean vector of each cluster, and a global covariance matrix calculated based on the mean vector.

A non-transitory computer readable recording medium storing a speech embedding program, when executed by a processor, that performs a method for: calculating, from a first sequence of feature vectors, a second sequence of frame-level feature vectors; calculating posterior probabilities for each vector included in the second sequence to a cluster; and calculating a sufficient statistic used for extracting an i-vector by using the second sequence, the posterior probabilities, a calculated mean vector of each cluster, and a global covariance matrix calculated based on the mean vector.

### Advantageous Effects of Invention

According to the present invention, it is possible to extract features in a mode that requires generative modeling, while improving the performance of speech processing application (e.g., speaker recognition).

### BRIEF DESCRIPTION OF DRAWINGS

FIG. 1

It depicts an exemplary block diagram illustrating the structure of an exemplary embodiment of a speech embedding apparatus according to the present invention.

FIG. 2

It depicts an explanatory diagram illustrating an example of a process of extracting an i-vector.

FIG. 3

It depicts a flowchart illustrating the process of the exemplary embodiment of the speech embedding apparatus according to the present invention.

FIG. 4

It depicts a block diagram illustrating an outline of the speech embedding apparatus according to the present invention.

FIG. 5

It depicts a schematic block diagram illustrating a configuration of a computer according to at least one of the exemplary embodiments.

FIG. 6

It depicts an explanatory example illustrating a general extraction example of the i-vector.

### DESCRIPTION OF EMBODIMENTS

The following describes an exemplary embodiment of the present invention with reference to drawings.

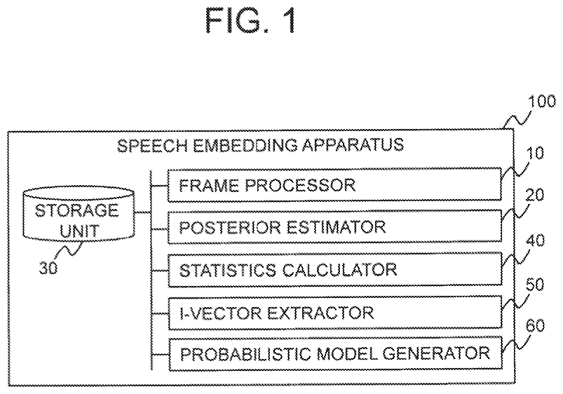

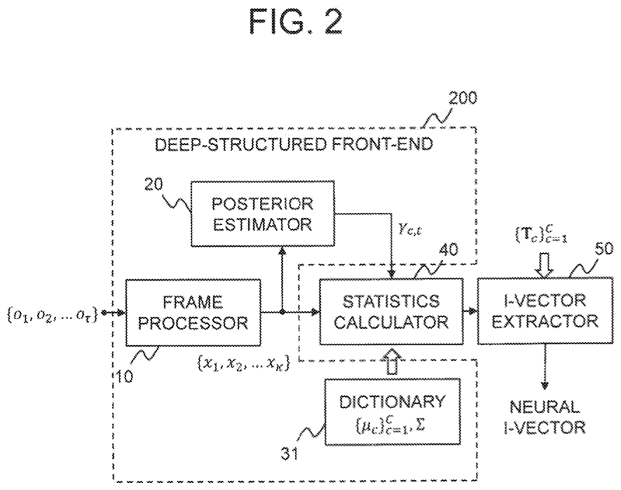

FIG. 1 depicts an exemplary block diagram illustrating the structure of an exemplary embodiment of a speech embedding apparatus according to the present invention. FIG. 2 depicts an explanatory diagram illustrating an example of a process of extracting an i-vector. The speech embedding apparatus 100 according to the present exemplary embodiment includes a frame processor 10, a posterior estimator 20, a storage unit 30, a statistics calculator 40, an i-vector extractor 50 and a probabilistic model generator 60.

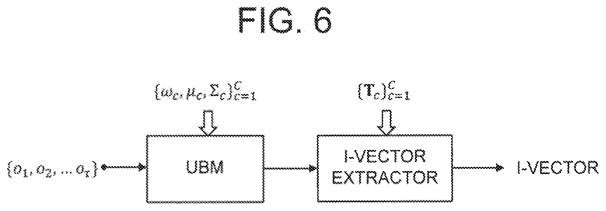

The frame processor 10 receives a sequence of feature vectors oₜ={o₁, o₂, . . . , o_{[tau]}} as shown in FIG. 2. The sequence of feature vectors oₜ is, for example, speech frames. As in the example shown in FIG. 6, an observation oₜ represents a feature vector of D dimensions at the time step t, and [tau] represents the number of feature vectors in a set or sequence of the observations.

Then, the frame processor 10 calculates a sequence of frame-level feature vectors xₜ={x₁, x₂, . . . , x_{[kappa]}} from the received sequence of feature vectors oₜ. In the following description, the received feature vector sequence oₜ is referred to as a first sequence, and the calculated frame-level feature vector sequence xₜ is referred to as a second sequence.

The frame processor 10 may calculate the second sequence (that is, the sequence of frame-level feature vectors) xₜ by implementing, for example, a neural network including multiple layers learnt in advance. The learning method of the frame processor 10 will be described later. When the neural network implemented by the frame processor 10 is described as f_{NeuralNet}, the second sequence xₜ is calculated, for example, by Equation 6 described below.

[Math. 4]

xₜ=f_{NeuralNet}(oₜ) (Equation 6)

The form of the neural networks implemented by the frame processor 10 are arbitrary. The neural networks may be TDNN layers, convolutional neural network (CNN) layers, recurrent neural network (RNN) layers, their variants, or their combination.

In the present exemplary embodiment, the time resolution of the second sequence may be the same as the time resolution of the first sequence or larger, that is [kappa]<=[tau].

The posterior estimator 20 calculates posterior probabilities for each element xₜ included in the second sequence x_{[kappa]} to a cluster. The cluster is generated when the frame processor 10 and the posterior estimator 20 are learnt. Hereinafter, the number of clusters is denoted as C, and the posterior probability of the element xₜ with respect to the cluster c is denoted as [gamma]_{c,t}.

The posterior estimator 20 may calculate the posterior probabilities by implementing, for example, a neural network learnt in advance. The learning method of the posterior estimator 20 will be described later. When the neural network implemented by the posterior estimator 20 is described as g_{NeuralNet}, the posterior probabilities are calculated, for example, by Equation 7 described below. In Equation 7, {v_{c}, b_{c}}_{c=1}^{C} is a fully connected layer implementation of an affine transformation.

$$[ Math . 5 ]$$

$${e}_{c , t} = {v}_{c}^{T} {g}_{NeuralNet} ( {x}_{t} ) + {b}_{c} {γ}_{c , t} = \frac{exp ( {e}_{c , t} )}{{\sum }_{l = 1}^{C} ( {e}_{l , t} )} where {\sum }_{c = 1}^{C} {γ}_{c , t} = 1 \qquad ( Equation 7 )$$

As described above, the posterior estimator 20 may calculate the posterior probabilities [gamma]_{c,t} for the c-th cluster of the feature vector (sequence of the feature vector) xₜ using the values calculated from the fully connected layers of the neural network learnt in advance.

The storage unit 30 stores a set of the {[mu]_{c}}_{c=1}^{C} of the average [mu]_{c} of each cluster c and a global covariance matrix [Sigma] calculated based on the average [mu]_{c} of each cluster c. Here, the average [mu]_{c} of the cluster c can be said to be the mean vector of each cluster, and can be said to indicate the centroid of the c-th cluster. The global covariance matrix [Sigma] is a covariance matrix shared by each cluster. Moreover, the mean vector of each cluster is calculated at the time of learning of the frame processor 10 and the posterior estimator 20.

In the following description, information in which the set of the {[mu]_{c}}_{c=1}^{C} of the average [mu]_{c} of each cluster c and a global covariance matrix [Sigma] may be described as a Dictionary (corresponding to Dictionary 31 in FIG. 2).

Here, a method of learning the frame processor 10, the posterior estimator 20, and the Dictionary (that is, {[mu]_{c}}_{c=1}^{C} and [Sigma]) stored in the storage unit 30 according to the present exemplary embodiment will be described. The frame processor 10, the posterior estimator 20, and the Dictionary are trained jointly to maximize speaker discrimination in advance.

The frame processor 10 and the posterior estimator 20 are implemented by a neural network or the like, and the Dictionary learnt together with them is used for a sufficient statistic calculation process described later. Therefore, a configuration including the frame processor 10, the posterior estimator 20, and the Dictionary 31 may be referred to as a deep-structured front-end (Corresponding to Deep-structured front-end 200 in FIG. 2).

The learning method of the deep-structured front-end is not particularly limited. For example, the frame processor 10, the posterior estimator 20, and the Dictionary may be trained jointly as in the NetVLAD framework disclosed in Non Patent Literature 4. In particular, the frame processor 10, the posterior estimator 20, and the Dictionary may be trained to minimize classification loss following the step as disclosed in Non Patent Literature 4.

Note that the posterior estimator 20 of the present exemplary embodiment uses the neural network g_{NeuralNet}(xₜ), while the NetVLAD framework disclosed in Non Patent Literature 4 uses the identity function (g_{NeuralNet}(xₜ)=xₜ). Furthermore, in the NetVLAD framework disclosed in Non Patent Literature 4, a covariance matrix is not used, but in the present exemplary embodiment, the Dictionary includes the mean vectors and a global covariance matrix.

The empirical estimate of the global covariance matrix is calculated from the second sequences x_{[kappa]}. Here, it is assumed that all sequences have the same length [kappa] and there are N sequences in the training set. In this case, the covariance matrix [Sigma] may be calculated, for example, by Equation 8 described below.

$$[ Math . 6 ]$$

$$Σ = \frac{1}{N τ} {\sum }_{∀ X} {\sum }_{c = 1}^{C} {\sum }_{t = 1}^{κ} {γ}_{c , t} ( {x}_{t} - {μ}_{c} ) {( {x}_{t} - {μ}_{c} )}^{T} \qquad ( Equation 8 )$$

The statistics calculator 40 uses the second sequence x_{[kappa]}, the posterior probability [gamma]_{c,t}, the mean vector [mu]₀ of each cluster, and the global covariance matrix [Sigma] to calculate a sufficient statistic used for extracting an i-vector. Specifically, the statistics calculator 40 calculates the zero-order statistic and the first-order statistic as the sufficient statistic. The statistics calculator 40 may calculate the zero-order statistic and the first-order statistic, for example, by Equations 9 and 10 described below.

[Math. 7]

N_{c}=Σₜ₌₁^{κ}γ_{c,t} (Equation 9)

F_{c}=Σ_{c}^{-1/2}[Σₜ₌₁^{τ}γ_{c,t}(xₜ−μ_{c})] (Equation 10)

The i-vector extractor 50 extracts the i-vector based on the calculated sufficient statistics. Specifically, the i-vector extractor 50 extracts the i-vector using the total variability matrix {T_{c}}_{c=1}^{C} of the c-th cluster as a parameter. For example, the i-vector extractor 50 may extract the i-vector using the zero-order statistic and the first-order statistic according to Equations 11 and 12 shown below.

[Math. 8]

ϕ=L⁻¹[Σ_{c=1}^{C}T_{c}^{T}F_{c}] (Equation 11)

L⁻¹=[Σ_{c=1}^{C}N_{c}T_{c}^{T}T_{c}+I]⁻¹ (Equation 12)

The total variability matrix of the cluster in the present exemplary embodiment corresponds to a total variability matrix of a generative Gaussian. Note that the training mechanism may follow the standard i-vector mechanism as disclosed in Non Patent Literatures 1, for example. In the present exemplary embodiment, since the i-vector is extracted using the neural network technology, the extracted i-vector can also be called a neural i-vector.

The probabilistic model generator 60 generates a probabilistic model. By sampling from this probabilistic model, new data can be generated. Let [phi] be the (neural) i-vector. The probabilistic model generator 60 may form the probabilistic model as shown in Equation 13 shown below.

[Math. 9]

p(xᵢ|ϕ)=Σ_{c=1}^{C}ω_{c}N(xₜ|μ_{c}+Σ^{1/2}T_{c}ϕ,Σ) (Equation 13)

where

$$N ( {x}_{t} \vert {μ}_{c} + {Σ}^{1 / 2} {T}_{c} ϕ , Σ ) = \frac{1}{\sqrt{{( 2 π )}^{K} \vert Σ \vert}} exp [ - \frac{1}{2} {( {x}_{t} - {μ}_{c} - {Σ}^{1 / 2} {T}_{c} ϕ )}^{T} {Σ}^{- 1} ( {x}_{t} - {μ}_{c} - {Σ}^{1 / 2} {T}_{c} ϕ ) ]$$

The frame processor 10, the posterior estimator 20, the statistics calculator 40, the i-vector extractor 50 and the probabilistic model generator 60 are implemented by a CPU of a computer operating according to a program (speech embedding program). For example, the program may be stored in the storage unit 130, with the CPU reading the program and, according to the program, operating as the frame processor 10, the posterior estimator 20, the statistics calculator 40, the i-vector extractor 50 and the probabilistic model generator 60. The functions of the speech embedding apparatus 100 may be provided in the form of SaaS (Software as a Service).

The frame processor 10, the posterior estimator 20, the statistics calculator 40, the i-vector extractor 50 and the probabilistic model generator 60 may each be implemented by dedicated hardware. All or part of the components of each device may be implemented by general-purpose or dedicated circuitry, processors, or combinations thereof. They may be configured with a single chip, or configured with a plurality of chips connected via a bus. All or part of the components of each device may be implemented by a combination of the above-mentioned circuitry or the like and program.

In the case where all or part of the components of each device is implemented by a plurality of information processing devices, circuitry, or the like, the plurality of information processing devices, circuitry, or the like may be centralized or distributed. For example, the information processing devices, circuitry, or the like may be implemented in a form in which they are connected via a communication network, such as a client-and-server system or a cloud computing system.

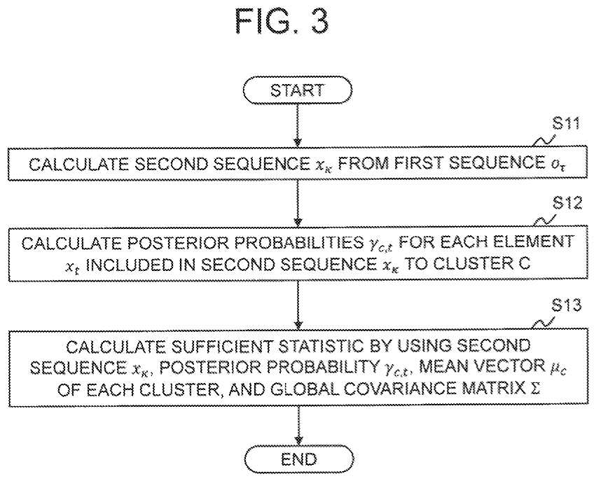

Next, an operation example of the speech embedding apparatus according to the present exemplary embodiment will be described. FIG. 3 depicts a flowchart illustrating the process of the exemplary embodiment of the speech embedding apparatus 100 according to the present invention.

The frame processor 10 calculates the second sequence x_{[kappa]} from the first sequence o_{[tau]} (Step S11). The posterior estimator 20 calculates the posterior probabilities [gamma]_{c,t} for each element xₜ included in the second sequence x_{[kappa]} to a cluster c (Step S12). The statistics calculator 40 calculates a sufficient statistic by using the second sequence x_{[kappa]}, the posterior probability [gamma]_{c,t}, the mean vector [mu]_{c} of each cluster, and the global covariance matrix [Sigma].

As described above, according to the present exemplary embodiment, the frame processor 10 calculates the second sequence x_{[kappa]} from the first sequence o_{[tau]}, the posterior estimator 20 calculates the posterior probabilities [gamma]_{c,t} for each element xₜ included in the second sequence x_{[kappa]} to a cluster c, and the statistics calculator 40 calculates a sufficient statistic by using the second sequence x_{[kappa]}, the posterior probability [gamma]_{c,t}, the mean vector [mu]_{c} of each cluster, and the global covariance matrix [Sigma]. Therefore, it is possible to extract features in a mode that requires generative modeling, while improving the performance of speech verification.

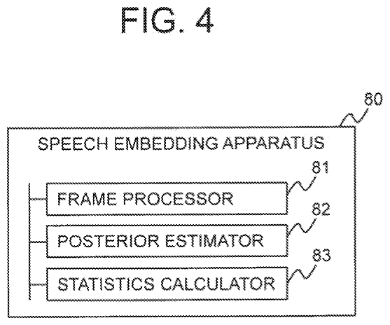

Next, an outline of the present invention will be described. FIG. 4 depicts a block diagram illustrating an outline of the speech embedding apparatus according to the present invention. The speech embedding apparatus 80 (for example, speech embedding apparatus 100) includes: a frame processor 81 (for example, the frame processor 10) which calculates, from a first sequence of feature vectors (for example, oₜ), a second sequence of frame-level feature vectors (for example, xₜ); a posterior estimator 82 (for example the posterior estimator 20) which calculates posterior probabilities (for example, [gamma]_{c,t}) for each vector included in the second sequence to a cluster; and a statistics calculator 83 (for example, the statistics calculator 40) which calculates a sufficient statistic used for extracting an i-vector by using the second sequence, the posterior probabilities, a mean vector (for example, [mu]_{c}) of each cluster calculated at the time of learning of the frame processor 81 and the posterior estimator 82, and a global covariance matrix (for example, [Sigma]) calculated based on the mean vector.

With such a configuration, it is possible to extract features in a mode that requires generative modeling, while improving the performance of speech processing application (e.g., speaker recognition).

Also, the frame processor 81 may calculate the second sequence by implementing a neural network including multiple layers learnt in advance.

Specifically, the neural network may include time-delay neural network layers, convolutional neural network layers, recurrent neural network layers, their variants, or their combination.

Also, the time resolution of the second sequence may be the same as the time resolution of the first sequence or larger.

Also, the posterior estimator 82 may calculate the posterior probabilities using the values calculated from fully connected layers of a neural network learnt in advance.

Also, the statistics calculator 83 may calculate a zero-order statistic and a first-order statistic as the sufficient statistic.

Also, the speech embedding apparatus 80 may include an i-vector extractor (for example, i-vector extractor 50) which extracts an i-vector using the calculated sufficient statistic.

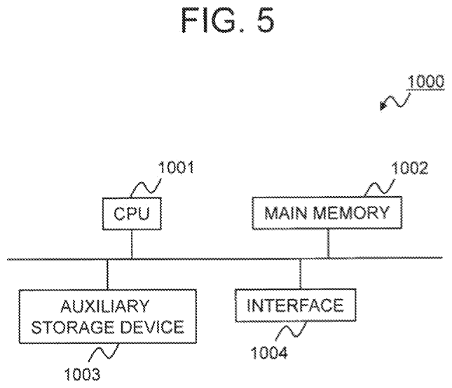

FIG. 5 depicts a schematic block diagram illustrating a configuration of a computer according to at least one of the exemplary embodiments. A computer 1000 includes a CPU 1001, a main memory 1002, an auxiliary storage device 1003, and an interface 1004.

Each of the above-described speech embedding apparatus is mounted on the computer 1000. The operation of the respective processing units described above is stored in the auxiliary storage device 1003 in the form of a program (a speech embedding program). The CPU 1001 reads the program from the auxiliary storage device 1003, deploys the program in the main memory 1002, and executes the above processing according to the program.

Note that at least in one of the exemplary embodiments, the auxiliary storage device 1003 is an exemplary non-transitory physical medium. Other examples of non-transitory physical medium include a magnetic disc, a magneto-optical disk, a CD-ROM, a DVD-ROM, and a semiconductor memory that are connected via the interface 1004. In the case where the program is distributed to the computer 1000 by a communication line, the computer 1000 distributed with the program may deploy the program in the main memory 1002 to execute the processing described above.

Incidentally, the program may implement a part of the functions described above. The program may implement the aforementioned functions in combination with another program stored in the auxiliary storage device 1003 in advance, that is, the program may be a differential file (differential program).

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

(Supplementary note 1) A speech embedding apparatus comprising: a frame processor which calculates, from a first sequence of feature vectors, a second sequence of frame-level feature vectors; a posterior estimator which calculates posterior probabilities for each vector included in the second sequence to a cluster; and a statistics calculator which calculates a sufficient statistic used for extracting an i-vector by using the second sequence, the posterior probabilities, a mean vector of each cluster calculated at the time of learning of the frame processor and the posterior estimator, and a global covariance matrix calculated based on the mean vector.

(Supplementary note 2) The speech embedding apparatus according to claim 1, wherein, the frame processor calculates the second sequence by implementing a neural network including multiple layers learnt in advance.

(Supplementary note 3) The speech embedding apparatus according to claim 2, wherein, the neural network includes time-delay neural network layers, convolutional neural network layers, recurrent neural network layers, their variants, or their combination.

(Supplementary note 4) The speech embedding apparatus according to any one of claims 1 to 3, wherein, the time resolution of the second sequence is the same as the time resolution of the first sequence or larger.

(Supplementary note 5) The speech embedding apparatus according to any one of claims 1 to 4, wherein, the posterior estimator calculates the posterior probabilities using the values calculated from fully connected layers of a neural network learnt in advance.

(Supplementary note 6) The speech embedding apparatus according to any one of claims 1 to 5, wherein, the statistics calculator calculates a zero-order statistic and a first-order statistic as the sufficient statistic.

(Supplementary note 7) The speech embedding apparatus according to any one of claims 1 to 6, further comprising an i-vector extractor which extracts an i-vector using the calculated sufficient statistic.

(Supplementary note 8) A speech embedding method comprising: calculating, from a first sequence of feature vectors, a second sequence of frame-level feature vectors; calculating posterior probabilities for each vector included in the second sequence to a cluster; and calculating a sufficient statistic used for extracting an i-vector by using the second sequence, the posterior probabilities, a calculated mean vector of each cluster, and a global covariance matrix calculated based on the mean vector.

(Supplementary note 9) The speech embedding method according to claim 8, wherein, the second sequence is calculated by implementing a neural network including multiple layers learnt in advance.

(Supplementary note 10) A non-transitory computer readable recording medium storing a speech embedding program, when executed by a processor, that performs a method for: calculating, from a first sequence of feature vectors, a second sequence of frame-level feature vectors; calculating posterior probabilities for each vector included in the second sequence to a cluster; and calculating a sufficient statistic used for extracting an i-vector by using the second sequence, the posterior probabilities, a calculated mean vector of each cluster, and a global covariance matrix calculated based on the mean vector.

(Supplementary note 11) The non-transitory computer readable recording medium according to claim 10, wherein, the second sequence is calculated by implementing a neural network including multiple layers learnt in advance.

### REFERENCE SIGNS LIST

10 Frame processor
20 Posterior estimator
30 Storage unit
31 Dictionary
40 Statistics calculator
50 I-vector extractor
60 Probabilistic model generator
100 Speech embedding apparatus

1. A speech embedding apparatus comprising:
a frame processor which calculates, from a first sequence of feature vectors, a second sequence of frame-level feature vectors;
a posterior estimator which calculates posterior probabilities for each vector included in the second sequence to a cluster; and
a statistics calculator which calculates a sufficient statistic used for extracting an i-vector by using the second sequence, the posterior probabilities, a mean vector of each cluster calculated at the time of learning of the frame processor and the posterior estimator, and a global covariance matrix calculated based on the mean vector.

2. The speech embedding apparatus according to claim 1,
wherein, the frame processor calculates the second sequence by implementing a neural network including multiple layers learnt in advance.

3. The speech embedding apparatus according to claim 2,
wherein, the neural network includes time-delay neural network layers, convolutional neural network layers, recurrent neural network layers, their variants or their combination.

4. The speech embedding apparatus according to any one of claims 1 to 3,
wherein, the time resolution of the second sequence is the same as the time resolution of the first sequence or larger.

5. The speech embedding apparatus according to any one of claims 1 to 4,
wherein, the posterior estimator calculates the posterior probabilities using the values calculated from fully connected layers of a neural network learnt in advance.

6. The speech embedding apparatus according to any one of claims 1 to 5,
wherein, the statistics calculator calculates a zero-order statistic and a first-order statistic as the sufficient statistic.

7. The speech embedding apparatus according to any one of claims 1 to 6, further comprising an i-vector extractor which extracts an i-vector using the calculated sufficient statistic.

8. A speech embedding method comprising:
calculating, from a first sequence of feature vectors, a second sequence of frame-level feature vectors;
calculating posterior probabilities for each vector included in the second sequence to a cluster; and
calculating a sufficient statistic used for extracting an i-vector by using the second sequence, the posterior probabilities, a calculated mean vector of each cluster, and a global covariance matrix calculated based on the mean vector.

9. The speech embedding method according to claim 8,
wherein, the second sequence is calculated by implementing a neural network including multiple layers learnt in advance.

10. A non-transitory computer readable recording medium storing a speech embedding program, when executed by a processor, that performs a method for:
calculating, from a first sequence of feature vectors, a second sequence of frame-level feature vectors;
calculating posterior probabilities for each vector included in the second sequence to a cluster; and
calculating a sufficient statistic used for extracting an i-vector by using the second sequence, the posterior probabilities, a calculated mean vector of each cluster, and a global covariance matrix calculated based on the mean vector.

11. The non-transitory computer readable recording medium according to claim 10, wherein, the second sequence is calculated by implementing a neural network including multiple layers learnt in advance.
